(19) United States
(12) Patent Application Publication
(10) Pub. No.: US 2026/0079738 A1
(43) Pub. Date: Mar. 19, 2026

(54) SOFTWARE LICENSING SYSTEM ON BLOCKCHAIN

(71) Applicant: eBay Inc., San Jose, CA (US)

(72) Inventor: Tsun Kwan Donald Siu, Fremont, CA (US)

(21) Appl. No.: 18/889,491

(22) Filed: Sep. 19, 2024

(51) Int. Cl. G06F 9/455; G06Q 20/12; G06Q 20/36; H04L 9/00; H04L 9/32

(52) U.S. Cl. CPC G06F 9/45558; G06Q 20/1235; G06Q 20/367; H04L 9/3213; H04L 9/50; G06F 2009/45562; G06Q 2220/18; H04L 2209/56

(57) ABSTRACT

Systems and methods are directed to managing access to a software instance stored on a virtual machine on a blockchain using a smart contract. The system receives, from a client device of a user, an authorization request to access the software instance. The authorization request can include a token associated with the user. In response to receiving the authorization request, the system accesses the smart contract. Based on the token, a determination is made, through the smart contract, whether the user is an owner of a license to the software instance. In response to determining that the user is the owner, a further determination is made, through the smart contract, whether the license has expired without renewal. Based on the license having expired without renewal, the smart contract autonomously triggers the virtual machine to destroy a container comprising the software instance.

### TECHNICAL FIELD

The subject matter disclosed herein generally relates to managing software licenses. Specifically, the present disclosure addresses systems and methods that manage software licenses and access to software instances on a blockchain.

### BACKGROUND

Software licenses enable software suppliers and developers to protect their products. Unauthorized copying and distribution of software can lead to revenue loss for these developers and suppliers and creates security risks for users. Additionally, licensing typically requires a single entity for validation and verification. This can be problematic if that entity fails or becomes comprised.

### BRIEF DESCRIPTION OF THE DRAWINGS

FIG. 1 is a diagram illustrating an example network environment suitable for managing software licensing on a blockchain, according to example implementations.

FIG. 2 is a flowchart illustrating a method for establishing an image of a software instance and a corresponding listing, according to example implementations.

FIG. 3 is a flowchart illustrating a method for establishing a license for a user, according to example implementations.

FIG. 4 is a flowchart illustrating a method for managing access to the software instance, according to example implementations.

FIG. 5 is a flow diagram illustrating interactions between components of the network environment when a user tries to access a software instance, according to example implementations.

FIG. 6 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that manages software licenses and access to software instances on a blockchain are discussed herein. In particular, example implementations provide a network environment where licenses are managed through smart contracts and the software instances (e.g., containers comprising the software instance on virtual machines on the blockchain) are destroyed when the license expires without renewal. By setting an expiration date within the smart contract, software licenses can automatically become void after a certain period of time. This ensures that users cannot continue using the software beyond the agreed-upon license duration. Additionally, by destroying the container comprising the software instance, there is no user trance and privacy can be maintained. Given that the virtual machine is on the blockchain, the destruction is public and cannot be altered.

The smart contract is also programmed to allow renewal of licenses upon payment or other predefined conditions. This can streamline the license renewal of licenses for both users and developers/software owners. It also reduces overhead and resources since the process occurs automatically without any external input.

As a result, example implementations provide a technical solution to the technical problem of enforcing software licenses. In particular, the technical solution uses smart contracts on a blockchain to enforce the software licenses. By using a decentralized blockchain network, dependency on a centralized authority for license validation is reduced. Additionally, the blockchain's transparent nature ensures that an expiration and renewal process is visible to all relevant parties, which provides transparency and accountability in the licensing process. Thus, users can verify the status and validity of their licenses, while developers/software owners can track usage and expiration data. Finally, the blockchain's immutability ensures that once a license expiration or renewal transaction is recorded, it cannot be altered or tampered with retroactively. This enhances the security and integrity of the licensing system.

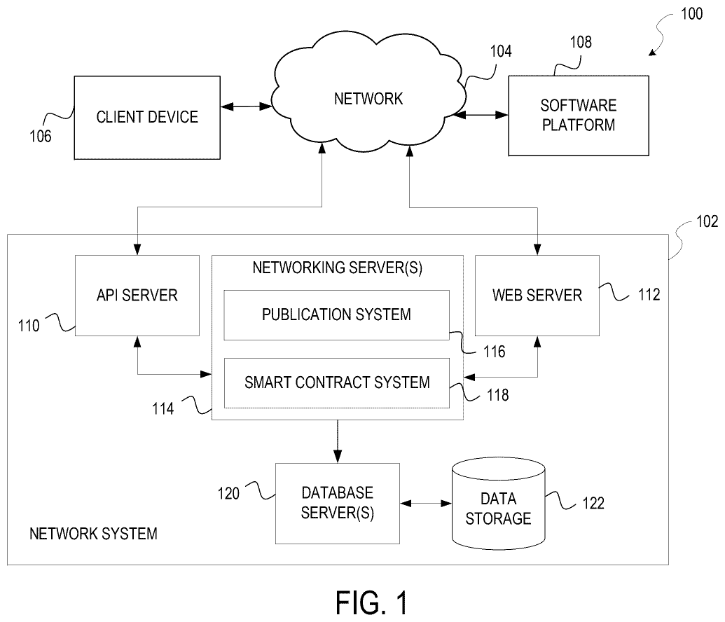

FIG. 1 is a diagram illustrating an example network environment 100 suitable for managing software licensing on a blockchain, according to example implementations. A network system 102 provides server-side functionality via a communication network 104 (e.g., the Internet, wireless network, cellular network, or a Wide Area Network (WAN)) to a client device 106. The network system 102 is configured to manage access, through a smart contract on the blockchain, to software instances that are licensed via the network system 102, as will be discussed in more detail below.

In various cases, the client device 106 is a device associated with a user of the network system 102, such as a seller of a software license (e.g., an owner of the software) or a user (e.g., buyer) that obtains a license to software. For example, the client device 106 can be a device associated with a user that uses the network system 102 to purchase the software license, access the software, and/or renew the software license via the network system 102. The client device 106 may comprise, but is not limited to, a smartphone, a tablet, a laptop, multi-processor systems, microprocessor-based or programmable consumer electronics, a desktop computer, a server, or any other communication device that can access the network system 102. The client device 106 can include an application that exchanges data, via the network 104, with the network system 102. For example, the application can be a wallet application or browser extension (e.g., for a digital wallet or MetaMask) or a local version of an application associated with the network system 102 that can provide data to and access data from one or more components at the network system 102.

In example implementations, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The software platform 108 may be a third-party system that triggers generation of containers that comprise software instances of the licensed software and provides access to the software instances to valid users (e.g., users that own a software license that has not expired). For example, the external processing system can be a Software as a Service (SaaS) off-chain system. During a listing process where the software licenses are listed for sale, the software platform 108 listens for a blockchain event (e.g., token minting by a seller on the blockchain using a smart contract). When the software platform 108 detect the token minting event, the software platform 108 initiates an image build process (e.g., a Docker image build process) and builds the image. The image comprises the software instance and services, and become containers at runtime or, in the case of Docker, when they run on Docker Engine. In one implementation, the images are built on an Ethereum Virtual Machine (EVM) or other compatible environment (e.g., Solana, Avalanche, BNB Chain), not on the blockchain, itself. Once the image is composed, it is uploaded to a decentralized storage or registry (e.g., Docker registry). The software platform 108 then interacts with the blockchain to update the smart contract with a uniform resource locator (URL) address of the image.

Turning specifically to the network system 102, an application programing interface (API) server 110 and a web server 112 are coupled to and provide programmatic and web interfaces respectively to one or more networking servers 114. The networking servers 114 host various systems including a publication system 116 and a smart contract system 118, each comprising a plurality of components and each of which can be embodied as a combination of hardware, software, and/or firmware. The networking servers 114 can comprise other system based on the nature of the network system 102. For example, the networking servers can comprise a separate transaction system and a customer service system.

The networking servers 114 can be, in turn, coupled to one or more database servers 120 that facilitate access to one or more storage repositories or data storage 122. The data storage 122 is a storage device storing, for example, user accounts including user profiles of users of the network system 102 and records of transactions or communications between the user and the network system 102 or other users of the network system 102.

The publication system 116 is configured to manage listings (e.g., publications of available goods or services) and transactions at the network system 102 including generating and publishing listings for the software licenses, conducting searches for the listings, and maintaining user accounts. The publication system 116 may comprise an account component that maintains and updates data associated with each user account by storing data to the data storage 122. For example, the user accounts can include indications of software licenses listed for sale by sellers on the network system 102.

The smart contract system 118 manages authentication of users and access to the software instances via the smart contracts associated with software licenses transacted via the network system 102. Additionally, the smart contract system 118 listens for blockchain events or periodically checks the smart contract. If the smart contract system 118 detects the URL update to the smart contract triggered by the software platform 108, the smart contract system 118 triggers the publication system 116 to finalize the listing and publish it on the network system 102.

For ease of discussion, example implementations discuss using a smart contract that is customized to the network system 102 on the Ethereum blockchain. However, other blockchains can be used (e.g., Solana, Avalanche, BNB Chain). Additionally, example implementations discuss the use of Docker images and containers. However, other platforms that package software and/or build containers (e.g., Podman, Buildha) can be used.

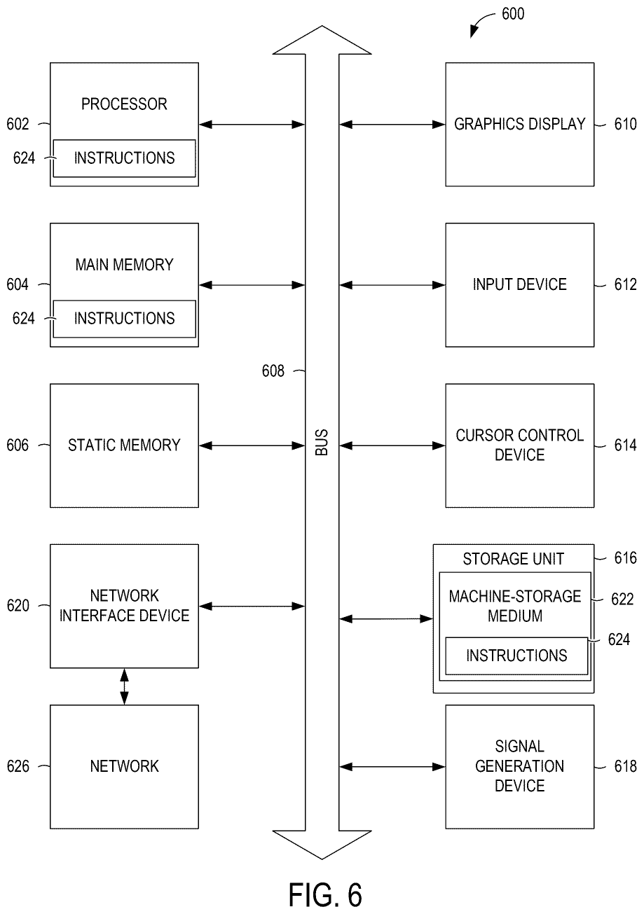

Any of the systems, data storage, servers, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client devices 106 and data storage 120 may be embodied within the network environment 100. While only a single network system 102 is shown, alternatively, more than one network system 102 can be included (e.g., localized to a particular region).

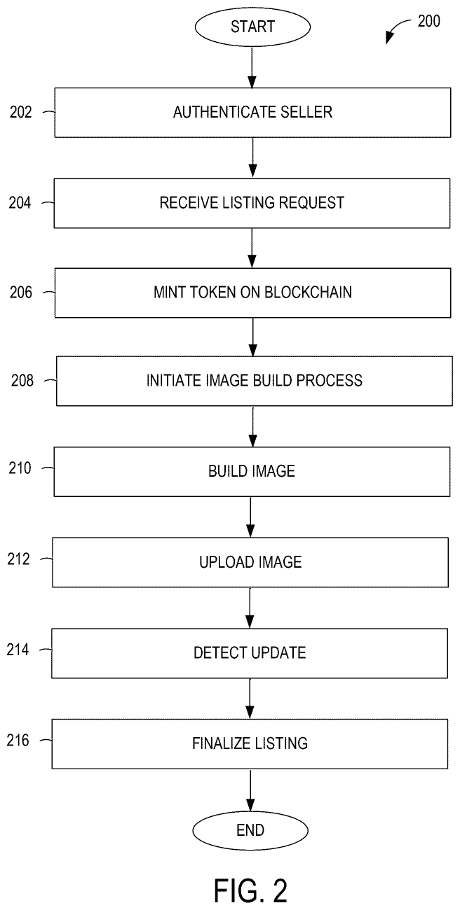

FIG. 2 is a flowchart illustrating a method 200 for establishing an image comprising a software instance and a corresponding listing, according to example implementations. Operations in the method 200 may be performed by components in the network environment 100, as described, in part, above with respect to FIG. 1. Accordingly, the method 200 is described by way of example with reference to components in the network environment 100. However, it shall be appreciated that at least some of the operations of the method 200 may be deployed on various other hardware configurations or be performed by similar components residing elsewhere in the network environment 100. Therefore, the method 200 is not intended to be limited to the implementation illustrated in FIG. 1.

Initially, a user (e.g., seller) that owns software initiates a process to list access to the software “for sale” on the network system 102. That is, the user has one or more licenses for sale, but does not want to disclose the license key to any buyers. As such, the user can deploy the software to a virtual machine and provide access through the network system 102.

In operation 202, the network system 102 authenticates the seller. For example, the seller may have an account with the network system 102 and provides credentials (e.g., username and password) that are verified by the network system 102.

In operation 204, the publication system 116 of the network system 102 receives a listing request. In example implementations, the seller creates one or more publications or listings that each indicate a service or software that is available. The listing can include terms, conditions, price, and a description of the software/service. The listing may also specify that delivery will be automated through a (buyer) smart contract of the network system 102.

In operation 206, a token is minted on the blockchain for the seller using a seller smart contract of the network system 102. The token represents ownership or the right to use the software. In example implementations, the minting can be performed via a decentralized application (DAPP) layer.

The minting action of operation 206 triggers an event or a call to an off-chain system, such as the software platform 108. The software platform 108 listens for blockchain events. When the software platform 108 detects a token minting event, the software platform 108 initiates an image build process in operation 208. The image build process, in one implementation, is a Docker image build process. The image is a template that contains instructions for creating a container and comprises a blueprint of libraries and dependencies required inside the container for an application to run.

In operation 210, the software platform 108 builds the image (e.g., Docker image), which contains a software instance and services. The building of the image can include creating, via the seller smart contract, a token that points to the software platform 108 that creates the image. It is noted that an image is built for each listing of the software. For example, if the seller lists ten licenses for the same software for sale, then ten images are created. In one implementation, the image is built on an Ethereum Virtual Machine (EVM). However, alternative implementations can build the image on other types of virtual machines.

In operation 212, the software platform 108 uploads the image to a decentralized storage or registry. For example, a Docker image can be uploaded to a Docker registry.

After the upload, the software platform 108 interacts with the blockchain to update the smart contract with a URL address to the image.

In operation 214, the smart contract system 118 of the network system 102 detects the update to the smart contract. In example implementations, the smart contract system 118 listens for blockchain events including the smart contract update or periodically checks the smart contract for the update.

In operation 216, the smart contract system 118 triggers the publication system 116 to finalize and publish the listing in response to detecting the update. The publication system 116 may also notify the seller that their software is now listed and available for purchase.

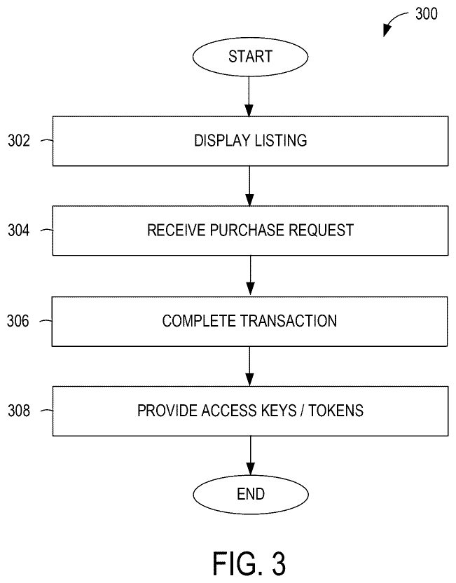

FIG. 3 is a flowchart illustrating a method 300 for establishing a license for a user (e.g., buyer) according to example implementations. Operations in the method 300 may be performed by the components in the network environment 100, as described, in part, above with respect to FIG. 1. Accordingly, the method 300 is described by way of example with reference to components in the network environment 100. However, it shall be appreciated that at least some of the operations of the method 300 may be deployed on various other hardware configurations or be performed by similar components residing elsewhere in the network environment 100. Therefore, the method 300 is not intended to be limited to the implementation illustrated in FIG. 1.

In operation 302, the network system 102 (e.g., the publication system 116) displays a listing with a software license for sale on the client device of a user. The listing includes an indication that delivery will be automated through a smart contract.

In operation 304, the network system 102 receives a purchase request from the client device 106 of the user. Assuming all terms and conditions are met, the network system 102 completes the transaction in operation 306.

Upon completion of the transaction, the smart contract releases necessary access keys or tokens to the user in operation 308. The access keys or tokens allow the user to pull the image (e.g., Docker image) and use the service associated with the software instance of the software. The access keys or tokens can be stored to a digital wallet (e.g., crypto wallet or MetaMask) associated with the user. In some cases, the crypto wallet is part of the client device 106.

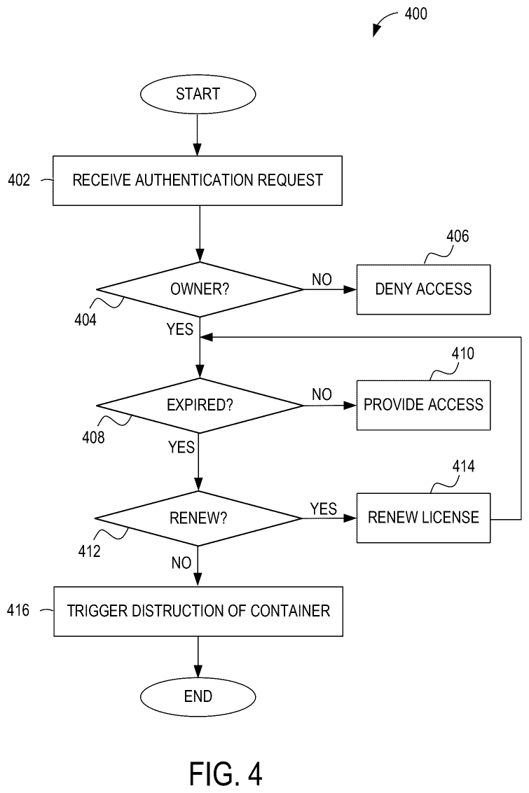

FIG. 4 is a flowchart illustrating a method 400 for managing access to the software instance, according to example implementations. Operations in the method 400 may be performed by the components in the network environment 100, as described, in part, above with respect to FIG. 1. Accordingly, the method 400 is described by way of example with reference to components in the network environment 100. However, it shall be appreciated that at least some of the operations of the method 400 may be deployed on various other hardware configurations or be performed by similar components residing elsewhere in the network environment 100. Therefore, the method 300 is not intended to be limited to the implementation illustrated in FIG. 1.

In operation 402, the smart contract system 118 on the network system 102 receives an authentication request from a user (e.g., a digital wallet of the user) that wants to access the software. The authentication request may include a token or access key associated with the user and/or software.

In operation 404, through the smart contract, a determination is made whether the user is the owner of the license. If the user is not the owner, then access is denied in operation 406. In example cases, a notification is transmitted to the user indicating that access has been denied.

If it is determined that the user is the owner, then, through the smart contract, a determination is made whether the license has expired in operation 408. If the license has not expired, then the user is provided access to the container comprising the software instance at the virtual machine. In some cases, a URL (hash key or other type of code) is created for the user to access the software (e.g., access the software instance of the container). The URL is returned to the device of the user, which provides automatic access to the software through the URL.

If the license has expired, the user can be presented a renewal option by the network system 102. For example, a notification can be provided to the user specifying terms for renewing the license. In operation 412, a determination is made whether the user renews the license. If the user renews, then the smart contract system 118 calls the smart contract to renew the license in operation 414. The method 400 then returns to operation 408, where the expiration is checked and access granted (operation 410).

If the license is not renewed and all expiration conditions are met, then the smart contract autonomously revokes access by triggering the destruction of the container comprising the software instance without the need for manual intervention. In example implementations, instructions are sent to the virtual machine on which the container resides to destroy the container. All traces that the user left in that software instance, such as the database, will be completely destroyed. Because the process is occurring on the blockchain, there is proof that the container was destroyed and cannot be altered.

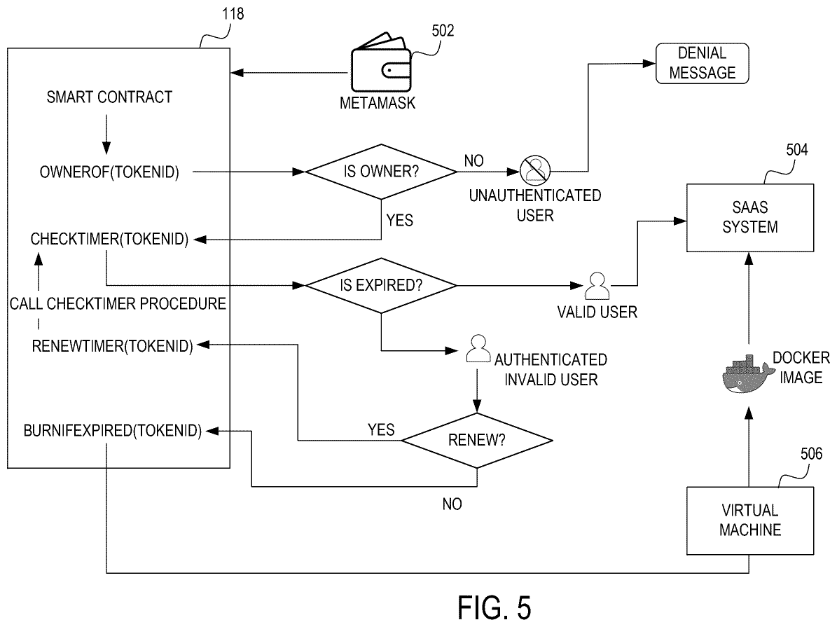

FIG. 5 is a flow diagram illustrating interactions between components of the network environment 100 when a user tries to access a software instance, according to example implementations. Initially, the user will attempt to authenticate with the network system 102. In example implementations, the user may use a digital wallet or MetaMask 502 to connect to the blockchain. The smart contract system 118 on the network system 102 receives the authentication request and tries to determine, through the smart contract, if the user is the owner of a license to the software (e.g., ownerof(tokenid)). If the user is not the owner (e.g., is an unauthenticated user), then the smart contract system 118 denies access. In example implementations, the smart contract system 118 transmits a notification to the user indicating that access has been denied.

If a determination is made that the user is the owner, then, through the smart contract, a determination is made whether the license has expired (e.g., checktimer(tokenid)). If the license has not expired, then the user is a valid user and is provided access to the software instance of the container through a Software as a Service (SaaS) system 504. In some cases, a URL (hash key or other type of code) is created for the user to access the software instance in the container) through the SaaS system 504. The URL is returned to the device of the user, which provides automatic access to the software through the URL. The SaaS system 504 accesses the corresponding image (e.g., Docker image) at the virtual machine (e.g., EVM) 506. In example implementations, the SaaS system 504 can be the same entity that created the image on the virtual machine 506. During runtime, the image becomes a container (e.g., the Docker image becomes the Docker container when it runs on a Docker Engine).

However, if the license has expired, the user is an authenticated invalid user and can be presented a renewal option by the smart contract system 118. Should the user renew, then the smart contract system 118 calls the smart contract (e.g., call checktimer procedure) to renew the license. The renewal can occur when the user satisfies all conditions for the extension of the license for another period of time.

If the license is not renewed, then the smart contract triggers the destruction of the container comprising the software instance (e.g., burnifexpired(tokenid)). In example implementations, instructions are sent to the virtual machine on which the container resides to destroy the container that contains the software instance. All traces that the user left in that software instance, such as the database, will be completely destroyed.

FIG. 6 illustrates components of a machine 600, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIG. 2-FIG. 4. In one implementation, the instructions 624 can transform the machine 600 into a particular machine (e.g., specially configured machine) programmed to carry out the described and illustrated functions in the manner described.

In alternative implementations, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more components described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example implementations, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### EXECUTABLE INSTRUCTIONS AND MACHINE-STORAGE MEDIUM

The various memories (e.g., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed implementations.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### SIGNAL MEDIUM

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### COMPUTER READABLE MEDIUM

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method for managing access to a software instance stored on a virtual machine on a blockchain using a smart contract. The method comprises receiving, from a client device of a user, an authorization request to access the software instance, the authorization request including a token associated with the user; in response to receiving the authorization request, accessing the smart contract; based on the token, determining, through the smart contract, whether the user is an owner of a license to the software instance; in response to determining that the user is the owner, determining, through the smart contract, whether the license has expired without renewal; and based on the license having expired without renewal, autonomously triggering, by the smart contract, the virtual machine to destroy a container comprising the software instance.

In example 2, the subject matter of example 1 can optionally include wherein the authorization request is received from a digital wallet associated with the client device.

In example 3, the subject matter of any of examples 1-2 can optionally include wherein the container is a Docker container on a Ethereum virtual machine.

In example 4, the subject matter of any of examples 1-3 can optionally include, based on a determination that the expiration date has passed, providing a renewal option to the user.

In example 5, the subject matter of any of examples 1-4 can optionally include receiving an acceptance of the renewal option; and in response to receiving the acceptance, calling the smart contract to renew the license to the software instance.

In example 6, the subject matter of any of examples 1-5 can optionally include receiving an indication to create a listing for a license to the software instance from a seller; in response to receiving the indication: creating the listing; triggering creation of an image comprising the software instance, the creation of the image triggering an update to the smart contract; and in response to detecting the update, publishing the listing.

In example 7, the subject matter of any of examples 1-6 can optionally include minting, using a seller smart contract, a further token on the blockchain that represents ownership rights, the minting triggering the creation of the image.

In example 8, the subject matter of any of examples 1-7 can optionally include wherein the image is uploaded to a decentralized storage or registry; and the update to the smart contract includes a uniform resource locator (URL) address of the image.

In example 9, the subject matter of any of examples 1-8 can optionally include receiving a purchase request from the user to purchase the license to the software instance; and in response to completion of a transaction associated with the purchase request, releasing, by the smart contract, one or more access keys or tokens to the user.

In example 10, the subject matter of any of examples 1-9 can optionally include, based on the license not having expired, providing access through a Software as a Service (SaaS) system to the software instance stored on the virtual machine.

Example 11 is a system for managing access to a software instance stored on a virtual machine on a blockchain using a smart contract. The system comprises one or more processors and a memory storing instructions that, when executed by the one or more processors, cause the one or more processors to perform operations comprising receiving, from a client device of a user, an authorization request to access the software instance, the authorization request including a token associated with the user; in response to receiving the authorization request, accessing the smart contract; based on the token, determining, through the smart contract, whether the user is an owner of a license to the software instance; in response to determining that the user is the owner, determining, through the smart contract, whether the license has expired without renewal; and based on the license having expired without renewal, autonomously triggering, by the smart contract, the virtual machine to destroy a container comprising the software instance.

In example 12, the subject matter of example 11 can optionally include wherein the authorization request is received from a MetaMask associated with the client device.

In example 13, the subject matter of any of examples 11-12 can optionally include wherein the container is a Docker container on a Ethereum virtual machine.

In example 14, the subject matter of any of examples 11-13 can optionally include wherein the operations further comprise, based on a determination that the expiration date has passed, providing a renewal option to the user; receiving an acceptance of the renewal option; and in response to receiving the acceptance, calling the smart contract to renew the license to the software instance.

In example 15, the subject matter of any of examples 11-14 can optionally include wherein the operations further comprise receiving an indication to create a listing for a license to the software instance from a seller; in response to receiving the indication: creating the listing; triggering creation of an image comprising the software instance, the creation of the image triggering an update to the smart contract; and in response to detecting the update, publishing the listing.

In example 16, the subject matter of any of examples 11-15 can optionally include wherein the operations further comprise minting, using a seller smart contract, a further token on the blockchain that represents ownership rights, the minting triggering the creation of the image.

In example 17, the subject matter of any of examples 11-16 can optionally include wherein the image is uploaded to a decentralized storage or registry; and the update to the smart contract includes a uniform resource locator (URL) address of the image.

In example 18, the subject matter of any of examples 11-17 can optionally include wherein the operations further comprise receiving a purchase request from the user to purchase the license to the software instance; and in response to completion of a transaction associated with the purchase request, releasing, by the smart contract, one or more access keys or tokens to the user.

In example 19, the subject matter of any of examples 11-18 can optionally include wherein the operations further comprise, based on the license not having expired, providing access through a Software as a Service (SaaS) system to the software instance stored on the virtual machine.

Example 20 is a computer-storage medium comprising instructions which, when executed by one or more processors of a machine, cause the machine to perform operations for managing access to a software instance stored on a virtual machine on a blockchain using a smart contract. The operations comprise receiving, from a client device of a user, an authorization request to access the software instance, the authorization request including a token associated with the user; in response to receiving the authorization request, accessing the smart contract; based on the token, determining, through the smart contract, whether the user is an owner of a license to the software instance; in response to determining that the user is the owner, determining, through the smart contract, whether the license has expired without renewal; and based on the license having expired without renewal, autonomously triggering, by the smart contract, the virtual machine to destroy a container comprising the software instance.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method of managing access to a software instance stored on a virtual machine on a blockchain using a smart contract, the method comprising:
receiving, from a client device of a user, an authorization request to access the software instance, the authorization request including a token associated with the user;
in response to receiving the authorization request, accessing the smart contract;
based on the token, determining, through the smart contract, whether the user is an owner of a license to the software instance;
in response to determining that the user is the owner, determining, through the smart contract, whether the license has expired without renewal; and
based on the license having expired without renewal, autonomously triggering, by the smart contract, the virtual machine to destroy a container comprising the software instance.

2. The method of claim 1, wherein the authorization request is received from a digital wallet associated with the client device.

3. The method of claim 1, wherein the container is a Docker container on a Ethereum virtual machine.

4. The method of claim 1, further comprising:
based on a determination that the expiration date has passed, providing a renewal option to the user.

5. The method of claim 4, further comprising:
receiving an acceptance of the renewal option; and
in response to receiving the acceptance, calling the smart contract to renew the license to the software instance.

6. The method claim 1, further comprising:
receiving an indication to create a listing for a license to the software instance from a seller;
in response to receiving the indication:
creating the listing;
triggering creation of an image comprising the software instance, the creation of the image triggering an update to the smart contract; and
in response to detecting the update, publishing the listing.

7. The method of claim 6, further comprising:
minting, using a seller smart contract, a further token on the blockchain that represents ownership rights, the minting triggering the creation of the image.

8. The method of claim 6, wherein:
the image is uploaded to a decentralized storage or registry; and
the update to the smart contract includes a uniform resource locator (URL) address of the image.

9. The method of claim 1, further comprising:
receiving a purchase request from the user to purchase the license to the software instance; and
in response to completion of a transaction associated with the purchase request, releasing, by the smart contract, one or more access keys or tokens to the user.

10. The method of claim 1, further comprising:
based on the license not having expired, providing access through a Software as a Service (SaaS) system to the software instance stored on the virtual machine.

11. A system for managing access to a software instance stored on a virtual machine on a blockchain using a smart contract, the system comprising:
one or more processors; and
a memory storing instructions that, when executed by the one or more processors, cause the one or more processors to perform operations comprising:
receiving, from a client device of a user, an authorization request to access the software instance, the authorization request including a token associated with the user;
in response to receiving the authorization request, accessing the smart contract;
based on the token, determining, through the smart contract, whether the user is an owner of a license to the software instance;
in response to determining that the user is the owner, determining, through the smart contract, whether the license has expired without renewal; and
based on the license having expired without renewal, autonomously triggering, by the smart contract, the virtual machine to destroy a container comprising the software instance.

12. The system of claim 11, wherein the authorization request is received from a MetaMask associated with the client device.

13. The system of claim 11, wherein the container is a Docker container on a Ethereum virtual machine.

14. The system of claim 11, wherein the operations further comprise:
based on a determination that the expiration date has passed, providing a renewal option to the user;
receiving an acceptance of the renewal option; and
in response to receiving the acceptance, calling the smart contract to renew the license to the software instance.

15. The system of claim 11, wherein the operations further comprise:
receiving an indication to create a listing for a license to the software instance from a seller;
in response to receiving the indication:
creating the listing;
triggering creation of an image comprising the software instance, the creation of the image triggering an update to the smart contract; and
in response to detecting the update, publishing the listing.

16. The system of claim 15, wherein the operations further comprise:
minting, using a seller smart contract, a further token on the blockchain that represents ownership rights, the minting triggering the creation of the image.

17. The system of claim 15, wherein:
the image is uploaded to a decentralized storage or registry; and
the update to the smart contract includes a uniform resource locator (URL) address of the image.

18. The system of claim 11, wherein the operations further comprise:
receiving a purchase request from the user to purchase the license to the software instance; and
in response to completion of a transaction associated with the purchase request, releasing, by the smart contract, one or more access keys or tokens to the user.

19. The system of claim 11, wherein the operations further comprise:
based on the license not having expired, providing access through a Software as a Service (SaaS) system to the software instance stored on the virtual machine.

20. A machine-storage medium comprising instructions which, when executed by one or more processors of a machine, cause the machine to perform operations for managing access to a software instance stored on a virtual machine on a blockchain using a smart contract, the operations comprising:
receiving, from a client device of a user, an authorization request to access the software instance, the authorization request including a token associated with the user;
in response to receiving the authorization request, accessing the smart contract;
based on the token, determining, through the smart contract, whether the user is an owner of a license to the software instance;
in response to determining that the user is the owner, determining, through the smart contract, whether the license has expired without renewal; and
based on the license having expired without renewal, autonomously triggering, by the smart contract, the virtual machine to destroy a container comprising the software instance.
